(19) United States
(12) Patent Application Publication
(10) Pub. No.: US 2004/0152441 A1
(43) Pub. Date: Aug. 5, 2004

(54) Wireless handset emergency location provisioning system (wireless HELPS)

(76) Inventor: Wai-See Candy Wong, Richmond HIll (CA)

Correspondence Address: REDKNEE INC., 2560 MATHESON BLVD. EAST, SUITE 500, MISSISSAUGA, ON, L4W4W9, CA

(21) Appl. No.: 10/218,486

(22) Filed: Aug. 15, 2002

Related U.S. Application Data
(60) Provisional application No. 60/394,530, filed on Jul. 10, 2002.

(51) Int. Cl. H04B 1/38

(52) U.S. Cl. 455/404.1; 455/557

(57) ABSTRACT

A personal safety system is proposed which facilitates the automatic identification and location of a wireless subscriber who may otherwise be in distress in tandem with, an additional means for messaging a list of pre-designated emergency contacts. In light of the Sep. 11, 2001 tragedy this invention becomes particularly salient.

### BACKGROUND ART

Owing largely to the advances and publicity surrounding Global Positioning Systems (GPS), personal/emergency location systems (and analogous art) remain quite widespread. Indeed, it seems unsurprising then that much of the relevant disclosures speak specifically to the incorporation of GPS technology, as with U.S. Pat. No. 6,362,778 to Neher, entitled Personal Location Detection System and U.S. Pat. No. 5,724,660 to Kauser et al., entitled Method and Apparatus for Locating a Mobile Station by Comparing Calculated Location Area with GPS Coordinates, for instance.

Other inventions call for the incorporation or utilization of some additional supplementary device or unit, as with U.S. Pat. No. 6,275,164 to MacConnell et al., entitled Emergency Locator System for instance; without considering the ubiquity and convenience of mobile phones and their existing infrastructure.

U.S. Pat. No. 5,742,666 to Alpert, entitled Emergency Mobile Telephone and U.S. patent application Ser. No. 20020057764 by Salvucci et al., entitled Real-Time Incident and Response Information Messaging in a System for the Automatic Notification that an Emergency Call has occurred from a Wireline or Wireless Device; both detail art akin to that disclosed herein however the technical means of implementation remain materially dissimilar to anyone versed thereof. Indeed, the invention of present aims at utilizing current and future advances in wireless and mobile technology, infrastructure and pervasiveness, towards providing a straightforward and innovative approach in situations of distress and tragedy.

References Cited:

U.S. Patent Documents

U.S. Patent Application

| | | | |
|---|---|---|---|
| 20020057764 | May 2002 | Salvucci et al. | 379/37 |
| U.S. Pat. No. 5,724,660 | March 1998 | Kauser et al. | 455/456 |
| U.S. Pat. No. 5,742,666 | April 1998 | Alpert | 455/404 |
| U.S. Pat. No. 6,275,164 | August 2001 | MacConnell et al. | 340/692 |
| U.S. Pat. No. 6,362,778 | March 2002 | Neher | 342/357 |

Other References

GSM 03.71, Digital cellular telecommunications system (Phase 2+); Location Services (LCS); (Functional description)—Stage 2

TIA/EIA/IS-J-STD-036, Enhanced Wireless 9-1-1 Phase II

### TECHNICAL FIELD

The present invention relates to telecommunication network implementations, and, in particular, to a method and system for messaging a list of pre-designated emergency contacts via a variety of messaging mechanisms.

### SUMMARY OF THE INVENTION

The Wireless Handset Emergency Location Provisioning System (Wireless HELPS) discloses art very much desirable in light of recent world events and tragedies, whereby an emergency communication application broadcasts a message to a list of pre-defined contacts upon receiving a distress signal from the wireless subscriber in question.

Said subscriber having first been provisioned into the Wireless Handset Emergency Location Provisioning System. At which time, the wireless subscriber must provide the method which s/he chooses to send out the distress signal. S/he may also include additional contacts to his/her emergency contacts list. For each contact, the subscriber must specify the method which the emergency message will be delivered (Short Message Service (SMS), e-mail, or voice call), the destination address of the contact, and the emergency message.

The Wireless Handset Emergency Location Provisioning System listens for distress signals sent by provisioned subscribers from their mobile phones in the form of Short Message Service (SMS), UnStructured Supplementary Services (USSD), or voice call. When a distress signal is received, the system looks up the subscriber's emergency contacts and the subscriber's location. After which time the system transmits the emergency message as defined by the subscriber and his/her location to all of his/her emergency contacts, as before.

Indeed, these features and other such advantages of the present invention shall readily become apparent from the following description and accompanying drawings.

### BRIEF DESCRIPTION OF THE DRAWINGS

FIG. 1 is a flow diagram of the subscriber provisioning feature of an embodiment of the present invention.

FIG. 2 is a block diagram of the emergency messaging and locating system according to an embodiment of the present invention.

### DETAILED DESCRIPTION OF THE PREFERRED EMBODIMENTS

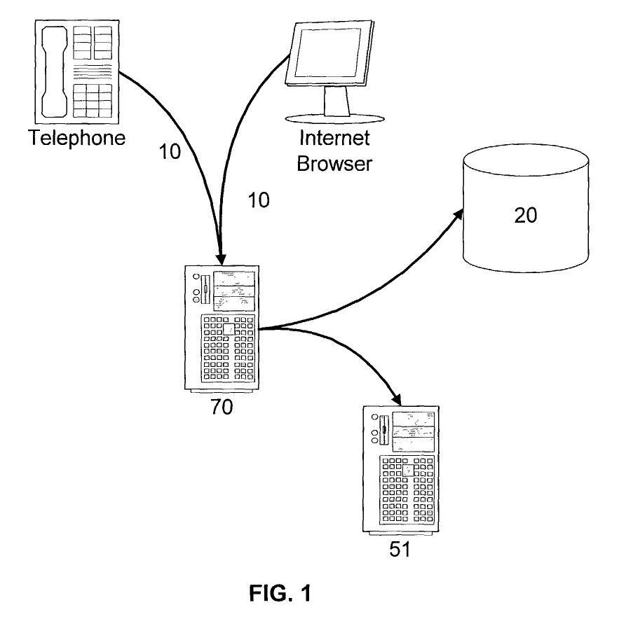

With reference now to FIG. 1, prior to implementing the emergency location provisioning and messaging system said wireless user must first access 10 the emergency location and contact provisioning application 70 and provision his or her identifier which may include the subscriber's Mobile Station Integrated Services Digital Network Number (MSISDN) or Mobile Directory Number (MDN) or Network Address Identifier (NAI) as a new subscriber to the emergency contact application 70. Those skilled in the art shall recognize that a variety of addressing schemes may be utilized as a form of subscription identification without diluting the intent and scope of the present invention; and indeed, will recognize further that a variety of mechanisms may be utilized in accessing 10 the emergency location and contact provisioning application including, but are by no means bounded by, Internet browser, voice-based call using speech-to-text technologies, and/or voice-based call using Dual-Tone-Multi-Frequency (DTMF) Interactive Voices Response based technologies. Having been received by the emergency contact application 70, the subscriber is thereby incorporated into the subscriber profile database 20. The wireless user will configure the contact provisioning application with the list of emergency contacts as well as associated addressing information which may include, but not be limited to, mobile telephone numbers, land-line telephone numbers, and e-mail addresses. The wireless user will also configure the contact provisioning application with the preferred means of messaging for each contact. The information pertaining to a given subscriber's emergency contact lists and associated messaging mechanism will be stored in a subscriber profile database 20 by the contact provisioning application. Readers skilled in the art will recognize that the wireless user may elect to configure and or alter the information resident in the subscriber profile database 20 via the use of the contact provisioning application upon initial subscription or at any point in time subsequent to the initial subscription procedure.

The emergency contact application 70 therewith registers the subscriber's addressing information to receive notification from the Short Message Service (SMS messaging) application 51 upon receipt of a distress signal. The registration sequence and notification will be received via a SMS Application Programming Interface (API). Indeed, those skilled in the art shall recognize that a variety of object oriented application programming interfaces will serve the purpose of notification without affecting the intent and scope of the present invention.

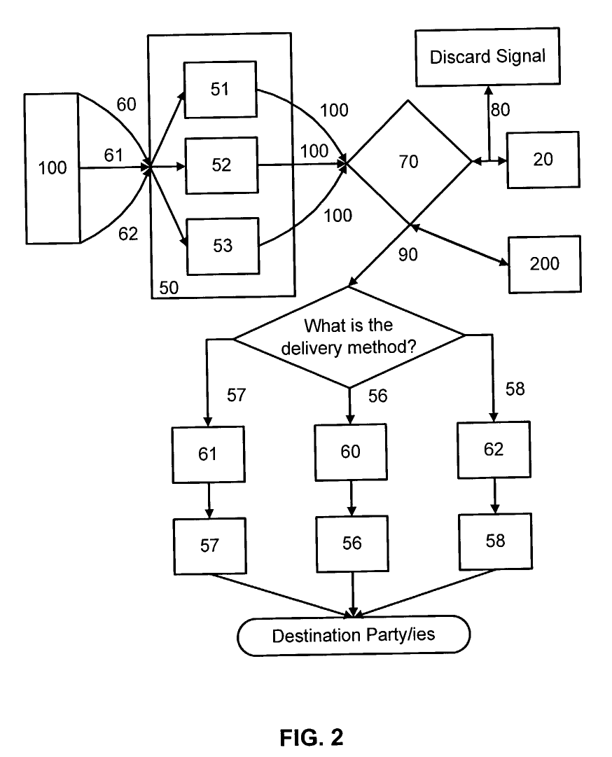

Now, in consideration of FIG. 2, the subscriber initiates a distress signal from his or her mobile phone 100 through a plurality of means, as Short Message Service (SMS) 60, UnStructured Supplementary Services (USSD) 61 or as a voice communication 62 to the emergency contact service 50. Members skilled in the art will recognize that a plurality of notification mechanisms may be implemented without causing detriment to the intent and scope of the present invention. The distress signal containing the subscriber identifier having been received forwards and parses said signal to the SMS API enabled service 51, USSD API enabled Service 52, or Call Control API enabled Service 53 as per the subscriber's pre-designated preference for distress signal delivery method.

The emergency contact service 50 notifies the emergency contact application 70 that a distress signal has been received and a query is made to determine if the originating subscriber identifier 100 remains a registered party to the service. Otherwise the signal is discarded 80. A service provider may elect to offer a basic unsubscribe level of service whereby a predefined configurable list of contact and associated addressing information is utilized to contact emergency response centers, public safety answering point services, or law enforcement agencies as the case may be.

The emergency contact application 70 then queries the subscriber profile database 20 for the emergency contact list for said subscriber. Upon return of such emergency contact list by the latter 20, the emergency contact application 70 then further optionally queries a Location-Based Service 200 via an API for the location of said subscriber. Where the latter 200 returns the subscriber's location, such information is appended by the emergency contact application 70 to the emergency message and sent to each contact as per the pre-defined method of delivery. The Location-Based Service will generally query the carrier's infrastructure through any number of mechanisms designed to retrieve the subscribers location as such. The plurality of which include, but are not to be limited by, the procedures and methods described in GSM 03.71 and TIA-J-STD-036 as revised periodically. The location information retrieved from the Location-Based Service 200 may nonetheless be inevitably constrained by the underlying location technology infrastructure deployed by a given carrier.

The subscriber's location and the subscriber's wireless handset (or mobile unit) 100 can essentially be considered equivalent, as the subscriber would be the one in possession of the unit initiating the distress signal. The emergency contact application 70 appends the location information to the emergency message 90 and sends it accordingly to each contact as per the pre-defined method of delivery.

The methods of delivery available include SMS 56, e-mail 57, and voice 58. The Service corresponding to each method of delivery (60, 61 and/or 62) relays the emergency message to the destination party. Those skilled in the art shall recognize indeed that other delivery notification mechanisms may be utilized without diluting the intent and scope of the present invention. A non-exhaustive sample list of destination parties include, emergency response centers, public safety answering point services, law enforcement agencies (default), and significant others as configured by the subscriber.

What is claimed is:

1. A comprehensive system, fully integrated with existing wireless/mobile handset technologies and infrastructure, for messaging a designated list of parties (including, by default, law enforcement agencies and related emergency response groups) and for providing the location of the said wireless user/subscriber in distress.

2. The system of claim 1, wherein said system and architecture comprise:
a. an interface (either web-based or telephonic) for the subscription and input of user data and other such provisioning information into the Wireless Handset Emergency Location Provisioning System;
b. a general purpose subscriber profile database;
c. a service for implementing the message parsing, filtering and relaying aspect of the system comprising a computer program on a computer readable memory medium;
d. an application for implementing the message management aspect of the system comprising a computer program on a computer readable memory medium;
e. a series of general purpose filters, parsers, databases and location enabling/determining services;

3. The system of claim 1, whereby wireless users/subscribers provisions his/her mobile phone as a new subscriber to the emergency contact application, with the requisite choice as to message content, delivery method and contact party list.

4. The system of claim 3, whereby the network operator provisions default contact information for the purpose contacting law enforcement agencies and related emergency response groups for a basic level of service to both subscribed and unsubscribed wireless users;

5. The system of claim 1, whereby said user's mobile handset communicates with the emergency contact service through the specified means providing the subscriber identifier and related information.

6. The system of claim 5, where the contact service further queries emergency contact application upon receipt of said distress signal to determine if user is party to the service/system.

7. The system of claim 6, whereby upon confirmation that wireless user in distress is party to said service/system, emergency contact application then further queries the general purpose subscriber profile database for information as contact party list, message content and method of delivery.

8. The system of claim 1, whereby wireless user's location is determined through a general purpose location enabling and/or determining service.

9. The system of claim 6, whereby the wireless subscriber's location is appended to the emergency contact application.

10. The system of claim 6, whereby the emergency message is built and includes the subscriber's location (where available) and relevant, specified
